(19) United States
(12) Patent Application Publication
(10) Pub. No.: US 2014/0165881 A1
(43) Pub. Date: Jun. 19, 2014

(54) ENGINEERED CELLULOSIC PRODUCTS

(71) Applicant: MMW EQUINE THERAPY PTY LTD, Tallebudgera Valley (AU)

(72) Inventors: Megan Ruth Pike, Tellebudgera Valley (AU); Anthony Douglas Pike, Tallebudgera Valley (AU)

(21) Appl. No.: 14/236,077

(22) PCT Filed: Aug. 1, 2012
(86) PCT No.: PCT/AU2012/000908

§ 371 Date: Jan. 30, 2014

(30) Foreign Application Priority Data
Aug. 1, 2011 (AU) 2011903067
Jun. 20, 2012 (AU) 2012902591

(51) Int. Cl. C08L 1/02; B27N 1/00

(52) U.S. Cl. CPC C08L 1/02; B27N 1/00
USPC 106/805; 536/56; 524/35; 106/126.3; 106/501.1; 156/62.2

(57) ABSTRACT

The present invention relates to engineered cellulosic products which comprise plant material from plants of the genus Cymbopogon. Methods of making the engineered cellulosic products are also described. The engineered cellulosic products include particle boards and fibre boards.

### FIELD OF THE INVENTION

The present invention relates generally to engineered cellulosic products which comprise plant material from plants from the genus Cymbopogon. The present invention also relates to processes for producing such cellulosic products.

### BACKGROUND OF THE INVENTION

The reference in this specification to any matter which is known, is not, and should not be taken as an acknowledgment or admission or any form of suggestion that that known matter forms part of the common general knowledge in the field of endeavour to which this specification relates.

Engineered wood products, such as particle board, medium density fibreboard and high density fibreboard, have become increasingly important in construction industries. Such products may be used in applications ranging from furniture manufacture to structural supports for buildings. Part of their appeal is that these products may be stronger than natural timber, and can be manufactured to meet precise industry standards.

However, the wood used to make the engineered wood products typically come from trees, such as radiata pine, and these trees can take decades to grow to a size where they can be harvested. Plantation timber operations therefore usually require large amounts of land so that trees may be continually harvested. This represents a large investment, not only in the land required, but also in running costs as machinery needs to be transported across a large area.

There is a need to provide engineered products from a material that grows quickly to a size where it can be harvested and which can be effectively used in the manufacture of such products.

### SUMMARY OF THE INVENTION

The present invention is predicated in part on the discovery that plant material from lemongrass (Cymbopogon) may be used to produce various engineered products. Lemongrass grows quickly and can be harvested a number of times each year. Furthermore lemongrass is fibrous, especially when it becomes more mature, which makes it suitable for use in the manufacture of engineered cellulosic products.

### DESCRIPTION OF THE INVENTION

In one aspect, the present invention relates to an engineered cellulosic product, comprising plant material from plants of the genus Cymbopogon.

The term “Cymbopogon” refers to any plant from the genus Cymbopogon. This includes Cymbopogon ambiguus, Cymbopogon bombycinus, Cymbopogon casesius, Cymbopogon commutatus, Cymbopogon citratus, Cymbopogon citriodora, Cymbopogon excavatus, Cymbopogon flexuosus, Cymbopogon goeringii, Cymbopogon jwarancusa, Cymbopogon martini, Cymbopogon nardus, Cymbopogon obtectus, Cymbopogon pendulus, Cymbopogon procerus, Cymbopogon proximus, Cymbopogon refractus, Cymbopogon schoenanthus and Cymbopogon winterianus. In one embodiment, the Cymbopogon plant species is selected from Cymbopogon ambiguus, Cymbopogon citratus, Cymbopogon flexiiosus, Cymbopogon nardus, and Cymbopogon refractus; especially selected from Cymbopogon citratus, Cymbopogon flexuosus and Cymbopogon nardus; and most especially Cymbopogon citratus. Other names for Cymbopogon plants include lemongrass, Camel's Hay, citronella, geranium grass, cochin grass and serah. The engineered cellulosic product may comprise one member of the genus Cymbopogon or a combination of members.

The Cymbopogon plant grows from the inside out. In a juvenile stage, the Cymbopogon plant has a series of layers of ring structures in the stem, and at this stage the plant is often harvested for culinary purposes or to collect the essential oil, citral, which is principally present in the uppermost third of the plant. At this stage the Cymbopogon plant has a high amount of leaf relative to stem. However, as the Cymbopogon plant matures the leaf starts to straighten and stand up, and the stem becomes firmer. Following this, the leaf extends and becomes straighter and the centre of the stem forms a single thick absorbent resilient fibrous layer. This stem is kinetic in strength, insulative and appears to have cellular memory attributes.

The Cymbopogon plant may be used to produce engineered cellulosic products at any stage of its growth cycle. However, in some embodiments, the Cymbopogon plant material does not include seeds, and the Cymbopogon plant especially is harvested at a time when the plant does not comprise seeds. In other embodiments, the Cymbopogon plant material does not comprise flowers, and the Cymbopogon plant especially is harvested at a time when the plant does not comprise flowers or seeds. In further embodiments, the Cymbopogon plant is harvested during a leaf straightening phase or at a time when the plant comprises flowers or seeds, especially during a leaf straightening phase. In some embodiments, the Cymbopogon plant is harvested before a leaf straightening phase.

The term “leaf straightening phase” refers to a time in the growth of the Cymbopogon plant in which the leaves stand or straighten, growing taller in height, and a firmer stem forms. In this leaf straightening phase, the stem initially is made of a series of layers, and the stem begins to form a fibrous exterior with a foam like core centre. It is believed that during or after the leaf straightening phase the Cymbopogon plant material is particularly well suited for use in engineered cellulosic products. There is generally a higher relative amount of stem in the Cymbopogon plant when the plant is in the leaf straightening phase, compared to before this phase. Flowers and seeds are not present in the leaf straightening phase.

The plant material used in the engineered cellulosic product may comprise any part of the Cymbopogon plant except for the root system. Typically, the Cymbopogon plant is harvested approximately 15 cm above ground level.

In one embodiment, the Cymbopogon plant material comprises leaves and stems of the Cymbopogon plant. In some embodiments, the Cymbopogon plant material consists essentially of leaves or consists essentially of stems, and the Cymbopogon plant material especially consists essentially of leaves. The relative amount of leaves and stems used depends on the desired engineered cellulosic product.

In some embodiments, the Cymbopogon plant is grown especially for the purpose of making engineered cellulosic products such as particle board. In other embodiments, the plants are grown for another purpose, such as the production of essential oils and the plant fibre is used after removal of the oil.

In one embodiment, the cellulose in the engineered cellulosic product comprises plant material from a plant of the genus Cymbopogon and at least one other source of cellulose, such as wood from the genus Pinus, especially pinus radiata (radiata pine). In another embodiment, the cellulose in the product consists essentially of plant material from a plant of the genus Cymbopogon. In a further embodiment, the cellulose in the product consists of plant material from a plant of the genus Cymbopogon.

The engineered cellulosic product is any man-made moulded product which comprises Cymbopogon plant material and which can be used as a substitute for solid timber, for example, in construction. In some embodiments, the engineered cellulosic product may be moulded using pressure and/or heat, and an adhesive may optionally be used. These products are typically suitable for use in a wide range of applications including, for example, as structural beams, flooring, panelling, doors, studs in framing/building, picture framing moulds, insulation, furniture, gardening stakes, rake and broom handles, or compressed bricks as a burning fuel (such as fire bricks). Advantageously, engineered cellulosic products comprising Cymbopogon plant material may be lighter in weight than analogues made from timber.

Exemplary engineered cellulosic products include particle board, medium-density fibreboard, high-density fibreboard (hardboard), oriented strand board, cement bonded particleboard, fibre cement siding, cross ply board, dimensioned timber analogues and fire bricks. The cross ply board comprises 2 or more layers of oriented cellulosic material (for example 2, 3, 4 or 5 ply board). The dimensioned timber analogue may be made from pieces of bound together Cymbopogon stem greater than 40 mm long, especially greater than 60 mm, 80 mm, 100 mm, 120 mm, 140 mm, 160 mm, 180 mm, 200 mm 250 mm, 300 mm, 350 mm, 400 mm, 450 mm or 500 mm long, more especially from 80 to 300 mm long, most especially from 100 to 250 mm long. The dimensioned timber analogue may also comprise pieces of bound together Cymbopogon stem which are much longer, for example, greater than 1500 mm long, especially greater than 1650 mm long, more especially greater than 1800 mm long. This dimensioned timber analogue may, for example, be used as a stud, stake, supporting beam, or the handle of, for example, a rake or broom. The term “engineered cellulosic product” does not include paper or cardboard.

The engineered cellulosic product may also include an adhesive to hold the cellulosic product together. However, inclusion of an adhesive may not be necessary for all engineered cellulosic products. For example, adhesive is not required in some high-density fibreboards or compressed bricks (such as fire bricks).

In some embodiments, the adhesive is a thermosetting or a thermoplastic polymer. A thermoplastic polymer is a polymer that is remouldable; it softens on heating and hardens on cooling. An exemplary thermoplastic polymer is polyvinylacetate (PVA). In contrast, a thermosetting polymer is a polymer that cures irreversibly. Exemplary thermosetting polymers include melamine, aldehyde, urea, isocyanate, phenolic, resorcinolic, and epoxy resins.

In another embodiment, the adhesive is a resin, especially a resin selected from a polyvinylacetate resin, a formaldehyde resin, a urea melamine resin, a melamine formaldehyde resin, a urea melamine formaldehyde resin, a phenol formaldehyde resin, a phenol melamine formaldehyde resin, a melamine resin, a urea formaldehyde resin, a melamine urea phenolic formaldehyde resin, a methylene diphenyl diisocyanate resin, a polymethylene diphenyl diisocyanate (such as polymethylenediphenyl-4,4′-diisocyanate)resin, or a combination thereof. The adhesive may especially be a formaldehyde resin, a urea melamine resin, a melamine formaldehyde resin, a phenol formaldehyde resin, a phenol melamine formaldehyde resin, a melamine resin, a urea formaldehyde resin, a melamine urea phenolic formaldehyde resin, a methylene diphenyl diisocyanate resin, a polymethylene diphenyl diisocyanate (such as polymethylenediphenyl-4,4′-diisocyanate)resin, or a combination thereof.

The adhesive may also be cement, such as in cement bonded particleboards or fibre cement siding. For other products such as compressed bricks (for example fire bricks), adhesives such as flour may be used. For some products, such as particleboards, soy flour may also be used as an adhesive.

In some embodiments, the amount of adhesive is in the range of 1 to 40% by weight and will depend on the adhesive used and the product being made. In some embodiments, the adhesive is a polyvinyl acetate resin and is present in an amount of 20 to 40% by weight. In other embodiments, the adhesive is a formaldehyde resin and is presenting an amount of 10 to 20% by weight. In yet other embodiments, the adhesive is an isocyanate resin and is present in an amount of 1 to 10%.

The engineered cellulosic product may also include other additives such as finishing agents, release agents, sand, dyes, waxes, hardeners, fire retardants, lubricants, fillers, plasticizers, pigments, biocides, formaldehyde scavengers or ultraviolet absorbers, or a combination thereof. For example, release agents may be used for particleboards and fibreboards, and sand may be used in fibre cement sidings.

In some embodiments, particularly where the adhesive is a hydrophilic resin, the engineered cellulosic product comprises a substance that increases the hydrophilicity of the surface of the plant material. The substance may be any hydrophilic substance that adheres, interacts or associates with the surface of the plant material increasing its hydrophilicity. In some embodiments, the hydrophilic substance is a polyhydroxy compound, a polycarboxylic acid, a hydroxy carboxylic acid, an amino acid or a hydroxy amino compound. Suitable polyhydroxy compounds include ascorbic acid, glycerine and carbohydrates such as glyceraldehyde, erythrose, threose, ribose, arabinose, xylose, lyxose, allose, alrose, glucose, mannose, gulose, idose, galactose, talose, sucrose, maltose, lactose, fructose or mixtures thereof, especially ascorbic acid. Suitable polycarboxylic acids include citric acid, tartaric acid, succinic acid, glutaric acid and adipic acid.

In some embodiments, the plant material is mixed or coated with the hydrophilic substance before mixing with the resin. The coating may occur by any suitable means that improves the hydrophilicity of the plant material, for example, dusting, spraying or painting, especially dusting.

In some embodiments, the hydrophilic substance is present in an amount of 0.1 to 15% by weight of the plant material, especially 1 to 10% by weight of plant material or 3 to 7% by weight, more especially 3 to 6% by weight, most especially 3 to 5% by weight. In some embodiments, the hydrophilic substance is present in an amount of 3.5 to 4% by weight.

The outer surface of the engineered cellulosic product may include a veneer. The veneer may be a wood veneer, or a plastic veneer. Suitable plastic veneers may include, for example, melamine and polyvinylchloride laminates.

The outer surface of the engineered cellulosic product may also include a finish, such as a finished formed from an adhesive. Suitable adhesives are as discussed above.

In another aspect, the present invention relates to a method of producing an engineered cellulosic product. The method comprises the steps of (i) processing plant material from a plant of the genus Cymbopogon, and (ii) moulding the processed plant material.

In one embodiment, the method further comprises harvesting the plant material prior to processing. The Cymbopogon plant may be harvested by cutting the stems off the plant approximately 15 cm above the ground. Some plants, such as Cymbopogon citratus, can grow to a size of about 3 m high and 3 m wide and can be harvested 3 to 4 times a year. Harvesting also promotes a mass growth period (shock growth) that can be as much as 25 mm per day. Each harvest can yield around 15 to 20 kg of Cymbopogon plant material per plant clump, and the entire harvest may be used to produce engineered cellulosic products. It is estimated that one plant of Cymbopogon citratus, harvested 4 times, would give a similar return in usable product as one tree grown and used for timber.

After the Cymbopogon plant material has been harvested, the harvested product may be dried and then stored before processing. For example, the harvested product may be stored for 2, 3, 4, 5 or 6 weeks, or for 2, 3, 4, 5, 6, 7, 8, 9, 10, 11 or 12 months. However, the Cymbopogon plant material may also be used immediately after harvest.

Processes for the production of a variety of engineered wood products, such as particle board, medium-density fibreboard, high-density fibreboard, oriented strand board, cement bonded particle board, fibre cement siding, and cross ply board are known, and similar processes may be used for the production of engineered cellulosic products comprising plant material from a Cymbopogon plant.

The steps involved in processing the Cymbopogon plant material in the method of the invention will vary depending on the engineered cellulosic product that is to be produced.

In one embodiment, the processing comprises cutting the Cymbopogon plant material to produce smaller plant pieces, for example by mulching or chipping the plant material. The plant material may be washed and dried before this step.

The size of the plant pieces after this cutting step will vary depending on the product that is to be produced. For example, for a dimensioned timber analogue the plant material may be cut into lengths of greater than 40 mm long, especially greater than 60 mm, 80 mm, 100 mm, 120 mm, 140 mm, 160 mm, 180 mm, 200 mm 250 mm, 300 mm, 350 mm, 400 mm, 450 mm or 500 mm long, more especially from 80 to 300 mm long, most especially from 100 to 250 mm long. In another embodiment, for a dimensioned timber analogue the plant material may be cut into lengths of greater than 1500 mm long, especially greater than 1650 mm long, more especially greater than. 1800 mm long. Alternatively, for particleboard, medium density fibreboard or high-density fibreboard the plant material is cut into fine particles. Longer pieces of plant material are used in grass boards or cross ply boards, and exemplary pieces of plant material in these boards are from 2 to 400 mm long, especially from 3 to 300 mm long, or from 5 to 200 mm long, most especially from 5 to 60 mm long, or from 40 to 120 mm long, or from 40 to 200 mm long.

The processing may comprise, after the cutting step, washing the plant material and then optionally drying the plant material. In some embodiments, either this washing step or the optional washing step prior to cutting the plant material may be conducted with water, especially at an elevated temperature, such as at 40, 50, 60, 70, 80, 90 or 100° C.

In some embodiments, the processing also comprises removing citral from the plant material, especially substantially removing the citral from the plant material. This may involve steam distillation. The citral obtained may be sold separately as an essential oil. In some embodiments, after removing the citral from the plant material the plant material is cut further, which may involve, for example, blending or mulching the material.

In one embodiment, the processing comprises contacting the Cymbopogon plant material with at least one other source of cellulose (for example, wood from the species Pinus, such as radiata pine) and optionally blending the plant material with the at least one other source of cellulose. In another embodiment, the sole source of cellulose used in the method of the invention is from the Cymbopogon plant.

Although in some embodiments no adhesive is necessary to make the engineered cellulosic product, in other embodiments the processing comprises binding the plant material together with an adhesive, optionally with at least one other source of cellulose. This binding step may include mixing the plant material, the adhesive and optionally at least one other source of cellulose together. The processing may also include contacting or blending an additive with the plant material. Suitable adhesives and additives are as discussed above. Prior to or during these steps, the Cymbopogon plant material or the mixture of plant material and the adhesive, the additive and/or the at least one other source of cellulose may be heated, and optionally treated with steam, to soften the plant material or the mixture. Water may also be optionally added with the adhesive.

The processing may also include orienting the fibres of the plant material from the plant of the genus Cymbopogon so that the fibres are aligned in substantially the same direction.

This step may be performed when producing cross ply board, oriented strand board, or a dimensioned timber analogue. In some embodiments, this orientation is performed before contacting the fibres with an adhesive or optionally an additive. In other embodiments, this orientation is performed after contacting the fibres with an adhesive and/or optionally an additive.

In other embodiments, the processing includes defibrating, such as when producing fibreboards.

After processing, the plant material is moulded, for example to form a flat or a curved board or brick. In some embodiments, the moulding step comprises heating the plant material to a temperature greater than 100° C. For example, the moulding step may include baking the plant material in an oven or over a fire. Exemplary heating temperatures include from 100° C. to 200° C., especially from 100° C. to 180° C., more especially approximately 100° C., 120° C., or 180° C.

The moulding step may also comprise compressing the plant material. In some embodiments, the moulding step comprises applying a force to the plant material that is equivalent to the gravitational force applied by a weight from 200 kg to 800 kg, especially from 300 kg to 700 kg, more especially from 400 kg to 600 kg, most especially about 500 kg.

In some embodiments, the moulding step comprises drying the compressed plant material. For example, the moulding step may comprise drying the compressed plant material in an oven or over a fire. Exemplary drying temperatures include from 100° C. to 200° C., especially from 100° C. to 180° C., more especially approximately 100° C., 120° C., or 180° C. The plant material may be compressed and subsequently dried one, two, three or four or more times to provide the desired shape.

In one embodiment, after moulding the engineered cellulosic product is sized to the desired dimensions. A veneer or a finish (such as an adhesive, as discussed above) may also be added to all or part of the outside of the product.

Advantageously, the Cymbopogon plant is hardy and generally requires little to no assistance between establishing the seedling and harvest. Typically pesticide treatment is not required. The plants are generally drought resistant and therefore do not need to be grown in prime agricultural land or require extensive irrigation. Furthermore, Cymbopogon plants, especially Cymbopogon citratus, possess an extensive root system that is capable of stabilising soil in any weather condition. Propagation of Cymbopogon plants may also be achieved by splitting an established plant, or by growing from seed. Cymbopogon plants grow in a wide variety of geographical areas, including Australia, Southeast Asia, southern India, Sri Lanka, Central Africa, Brazil, Guatemala, the United States of America and the West Indies.

Plants from the Cymbopogon genus also have antifungal and/or antibacterial properties. Products made from Cymbopogon plant material may also be resistant to fungi and/or to bacteria, and such products may also have inherent resistance to termite attack. It is believed that these properties may be enhanced if the citral is retained in the plant material used to make the engineered cellulosic products.

In one aspect of the invention there is provided a particle board comprising:
(a) plant material from a plant of the genus Cymbopogon, and
(b) an adhesive.

In some embodiments, the plant material from the genus Cymbopogon is from the species Cymbopogon citratus, Cymbopogon flexuosus or Cymbopogon nardus or a mixture thereof. In some embodiments, the adhesive is a resin, especially a resin selected from a formaldehyde resin such as a melamine urea formaldehyde resin, or an isocyanate resin such as a polymethylene diphenyl diisocyanate resin.

In some embodiments the particle board further comprises a hydrophilic substance, especially a polyhydroxy compound. In some embodiments, the polyhydroxy compound is ascorbic acid. In some embodiments, the hydrophilic substance is present in an amount of 0.1 to 15% by weight of the plant material, especially 3 to 7% by weight of the plant material.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

Throughout the specification and the claims which follow, the phrase “consist essentially of”, and variations such as “consists essentially of and “consisting essentially of”, is understood to imply that the recited integer or step or group of integers or steps are essential. The phrase allows for the presence of other non-recited integers or steps or group of integers or steps which do not materially affect the characteristics of the invention, but excludes additional unspecified elements which would affect the basic characteristics of the product.

The invention will now be described with reference to the following Examples which illustrate some aspects of the present invention. However, it is to be understood that the particularity of the following Examples is not to supersede the generality of the preceding description of the invention.

### EXAMPLES

### Example 1

### 8 mm Grass Board

Cymbopogon citratus plants in a leaf straightening phase were harvested by securing the plant material together with a rope, and then cutting the secured plant material with a chain saw approximately 15 cm above ground level. The harvested plant material was dried as a cut plant for about 3 to 4 weeks undercover on an open deck.

The dried plant material was mulched by feeding the plant material stem-first into a semi-commercial garden chip shredder mulcher, and collecting the mulched plant material in a trailer. This reduced the size of the plant material to pieces approximately 40 to 120 mm long.

The mulched product was allowed to dry for approximately 30 minutes. Approximately 250 g mulched product was then mixed with approximately 100 mL polyvinylacetate (PVA) in a mixing bowl. The mulched product was mixed with the PVA until the mulched product was evenly covered.

A 210 mm×300 mm metal baking dish, which was 50 mm deep, was lined with aluminium foil. The PVA mixture was added to the lined baking dish, evenly spreading the mixture. After the PVA mixture was added, the dish was approximately ¾ full. The top of the tray was then covered with newspaper and the mixture was manually pressed by hand into the tray.

The PVA mixture was baked for 15-20 min in a fan-forced oven at 120° C. After this baking, the heated product was placed lengthwise on a flat board which was covered in Glad®Wrap, and another flat board covered in Glad®Wrap was placed on top. A 200 series Toyota. Land Cruiser 2007 model (with a bulbar) was used to compress the heated product, by driving the driver's side wheel onto the uppermost flat board. The wheel was rolled back and forth once or twice, before the wheel was placed directly over the centre of the heated product. It is estimated that the weight applied to the product was approximately 500 kg. After 15 minutes the Land Cruiser was driven off the board, and the compressed product was placed on a flat tray and baked for a further 15 min in the fan-forced oven. After this, the compression procedure was repeated for a further 15 min, producing a grass board.

The aluminium foil and the newspaper were removed from the grass board, which was allowed to dry overnight on a tray. Following this, one side of the grass board was painted with PVA and allowed to sundry.

After drying for 2-3 days, the board was heated with a heat gun and then the compression procedure above was repeated. This process produced a 205mm×315 mm×8 mm grass board. The edges of the board were trimmed with scissors to obtain a straight edge.

### Example 2

### 5 mm Grass Board

A 5 mm thick grass board was produced in the same way as the 8 mm grass board of Example 1, except slightly less material was used. The mulched material included more leaf than stem. The final dimensions of the board were 220 mm×315 mm×5 mm.

### Example 3

### 20 mm Grass Board

A 20 mm thick grass board was produced in a similar way as the 8 mm grass board of Example 1, except that more material was used and a fire was used to bake the PVA mixture rather than an oven. The final dimensions of the board were 40 mm×1400 mm×20 mm.

### Example 4

### 15 mm Grass Board

A 15 mm thick grass board was produced in a similar way as the 8 mm grass board of Example 1, except that more material was used and a fire was used to bake the PVA mixture rather than an oven. The final dimensions of the board were 140 mm×1500 mm×15 mm.

### Example 5

### Other Grass Boards

Further grass boards were produced in a similar way as the 8 mm grass board of Example 1. When making these boards, the Cymbopogon citratus plants were harvested before the leaf straightening phase. The cut plant material was stored for about 7 months before it was mulched.

A similar product was also made from Cymbopogon citratus plants harvested in a leaf straightening phase. This product was made from only the skin of the stem of the harvested plant material. The skin was shaved from the outside and then processed as for Example 1.

### Example 6

### 3 Ply Grass Board

Cymbopogon citratus plants in a leaf straightening phase were harvested by securing the plant material together with a rope, and then cutting the secured plant material with a chain saw approximately 15 cm above ground level. The harvested plant material was dried as a cut plant for about 3 to 4 weeks undercover on an open deck.

Leaves from the dried cut plant were hand cut with scissors to provide leaf pieces 40 mm to 120 mm long. The cut leaf pieces were placed in a container and polyvinylacetate (PVA) was mixed through so that the leaf pieces were evenly coated with PVA. The PVA mixture included approximately 3 parts of cut leaf pieces to 1 part PVA.

A 210 mm×300 mm metal baking dish, which was 50 mm deep, was lined with aluminium foil, and the PVA mixture was added to the lined baking dish, placing the leaf pieces in the dish such that a first layer was placed in the dish widthways, a second layer lengthways, and a third layer widthways. This created a 3 ply effect. The top of the tray was covered with newspaper and the mixture was manually pressed by hand into the tray.

The PVA mixture was then baked for 20 min in a fan-forced oven at 100° C. After this baking, the heated product was placed lengthwise on a flat board which was covered in Glad®Wrap, and another flat board covered in Glad®Wrap was placed on top. A 200 series Toyota Land Cruiser 2007 model (with a bulbar) was used to compress the heated product, by driving the driver's side wheel onto the uppermost flat board. The wheel was rolled back and forth once or twice, before the wheel was placed directly over the centre of the heated product. After 15 minutes the Land Cruiser was driven off the board, and the compressed product was placed on a flat tray and baked for a further 20 min in the fan-forced oven. After this, the compression procedure was repeated for a further 15 min, producing a 3 ply board.

The aluminium foil and the newspaper were removed from the 3 ply board, although some of the newspaper remained stuck. The 3 ply board was allowed to dry on a baking tray and rack, and after drying any remaining newspaper was sanded off with a belt sander.

After drying for 2-3 days, the board was heated with a heat gun and then the compression procedure above was repeated. This process produced a 190 mm×280 mm 3 ply board, which was 5-6 mm thick. The edges of the board were trimmed with scissors to obtain a straight edge.

### Example 7

### 4 Ply Grass Board

Cymbopogon citratus plants in a leaf straightening phase were harvested by securing the plant material together with a rope, and then cutting the secured plant material with a chain saw approximately 15 cm above ground level. The harvested plant material was dried as a cut plant for about 3 to 4 weeks undercover on an open deck.

Leaves and stems from the dried cut plant were hand cut with scissors to provide plant pieces 40 mm to 200 mm long. The cut plant pieces were placed in a container and polyvinylacetate (PVA) was mixed through so that the pieces were evenly coated with PVA. The PVA mixture included approximately 3 parts of cut plant pieces to 1 part PVA.

A 210 mm×300 mm metal baking dish, which was 50 mm deep, was lined with aluminium foil, and the PVA mixture was added to the lined baking dish, placing the leaf pieces in the dish such that a first layer was placed in the dish lengthways, a second layer widthways, a third layer lengthways, and a fourth layer widthways. Decorative seeds from other plants were placed on top of the fourth layer. This created a 4 ply effect. The top of the tray was covered with newspaper and the mixture was manually pressed by hand into the tray.

The PVA mixture was then baked for 20 min in a fan-forced oven at 100° C. After this baking, the heated product was placed lengthwise on a flat board which was covered in Glad®Wrap, and another flat board covered in Glad®Wrap was placed on top. A 200 series Toyota Land Cruiser 2007 model (with a bulbar) was used to compress the heated product, by driving the driver's side wheel onto the uppermost flat board. The wheel was rolled back and forth once or twice, before the wheel was placed directly over the centre of the heated product. After 20 minutes the Land Cruiser was driven off the board, and the compressed product was placed on a flat tray and baked for a further 20 min in the fan-forced oven at 100° C. After this, the compression procedure was repeated for a further 20 min, producing a 4 ply board.

The aluminium foil and the newspaper were removed from the 4 ply board, although some of the newspaper remained stuck to the seeds. The 4 ply board was allowed to dry on a rack, and after drying the 4 ply board was sanded with a belt sander. The sanded sides of the board were coated, one at a time, with a thin layer of PVA using a paint brush. Approximately 20 mL of PVA was used on each side of the board.

After drying for 2-3 days, the board was heated with a heat gun and then the compression procedure above was repeated. This process produced a 220 mm×265 mm 4 ply board, which was 12 mm thick.

### Example 8

### 390 mm Stake

Cymbopogon citratus plants in a leaf straightening phase were harvested by securing the plant material together with a rope, and then cutting the secured plant material with a chain saw approximately 15 cm above ground level. The harvested plant material was dried as a cut plant for about 3 to 4 weeks undercover on an open deck.

Leaves and stems from the dried cut plant were cut in lengths from 100 mm to 250 mm. The plant material was approximately two-thirds stem and one-third leaf. The cut plant pieces were then placed in a mixing bowl and polyvinylacetate (PVA) was mixed through so that the pieces were evenly coated with PVA. The PVA mixture included approximately 2.5 parts of cut plant pieces to 1 part PVA. The PVA mixture was placed on a sheet of aluminium foil, layering the pieces lengthways, before wrapping the mixture in aluminium foil. The resultant stake was slightly twisted and squashed by hand to obtain the desired cylindrical shape.

The stake was baked for 1 hour in a fan-forced oven at 100° C. After this baking, the stake was squashed by hand, and cable ties were applied to provide the desired shape. The stake was baked in the fan-forced oven at 100° C. for a further 30 min.

The aluminium foil was removed between the cable ties, and the stake was left to dry on a rack. Once the stake was dry to the touch, the cable ties and the remainder of the aluminium foil were removed and the stake was allowed to dry further. The ends of the stake were cut to neaten the ends, and the stake was then sanded with a belt sander. This process produced a stake 390 mm long, with a diameter of 25-30 mm.

### Example 9

### 1800 mm Stake

Cymbopogon citratus plants in a leaf straightening phase were harvested by securing the plant material together with a rope, and then cutting the secured plant material with a chain saw approximately 15 cm above ground level. The harvested plant material was dried as a cut plant for about 3 to 4 weeks undercover on an open deck.

Leaves and stems from the dried cut plant were cut in 1800 mm lengths. The cut plant pieces were then mixed with polyvinylacetate (PVA) so that the pieces were evenly coated. The PVA mixture included approximately 2.5 parts of cut plant pieces to 1 part PVA. The PVA mixture was placed on a sheet of aluminium foil, layering the pieces lengthways and alternating so that the base of the stem of one plant piece was placed with the top of the stem of the next. The mixture was then wrapped in aluminium foil and the resultant stake was slightly twisted and squashed by hand to obtain the desired cylindrical shape.

The stake was baked for 15 min over a fire, and cable ties were applied during baking to provide the desired shape. After baking, the aluminium foil was removed between the cable ties, and the stake was left to dry on a rack. Once the stake was dry to the touch, the cable ties and the remainder of the aluminium foil were removed and the stake was allowed to dry further. The ends of the stake were cut to neaten the ends, and the stake was then sanded with a belt sander. This process produced a stake 1800 mm long, with a diameter of 45 mm.

### Example 10

### Moulded Shape

Cymbopogon citratus plants in a leaf straightening phase were harvested by securing the plant material together with a rope, and then cutting the secured plant material with a chain saw approximately 15 cm above ground level. The harvested plant material was dried as a cut plant for about 3 to 4 weeks undercover on an open deck.

Leaves were removed by hand from the dried harvested plant material. These leaves were steamed in a still at 98° C. for 15-20 min, distilling approximately 2.5 litres of organic liquid. The still included heating coils and water at the base, and a wire net where the leaves were placed. The wire net was positioned in the still to keep the plant material out of the water.

The steamed leaves were dried in the sun for about 20 min, before they were placed in a blender and blended on high for 2 min, reducing the size of the plant material ‘to about 5-60 mm in length. No water was added during this blending step. This procedure was repeated 3 times to obtain approximately 400 g blended plant material. This blended plant material was mixed with approximately 400 g polyvinylacetate (PVA) for about 5 minutes.

A 210 mm×300 mm metal baking dish, which was 50 mm deep, was lined with aluminium foil, and the PVA mixture was added to the lined baking dish. The top of the tray was covered with newspaper and the mixture was manually pressed by hand into the tray. After this, the PVA mixture was approximately 40 mm deep in the tray.

The PVA mixture was then baked for 30 min in a fan-forced oven at 120° C. After this baking, the heated product was placed lengthwise on a flat board which was covered in Glad®Wrap, and another flat board covered in Glad®Wrap was placed on top. A 200 series Toyota Land Cruiser 2007 model (with a bulbar) was used to compress the heated product, by driving the driver's side wheel onto the uppermost flat board. The wheel was rolled back and forth once or twice, before the wheel was placed directly over the centre of the heated product. After 15 minutes the Land Cruiser was driven off the board, and the compressed product was baked for a further 30 min in the fan-forced oven at 120° C. After this, the compression procedure was repeated for a further 15 min, and then the aluminium foil and the newspaper were removed, producing a grass board.

The grass board was allowed to dry in the sun and undercover. After 2 days drying, the sides of the board were flexed together, forming a “U” shape. The board was then placed over a balustrade and left to further dry for 2 days. Once dry to the touch (4 days) the outside surface of the “U” shape was painted with about 30 mL PVA, and heat from a heat gun was applied to this surface to help dry the PVA.

This process produced a moulded shape. The shape is 10 mm thick and 320 mm long. If the shape were flattened, it would be 250 mm wide at one end (the top), and 260 mm wide at the other end (the base). The shape forms an arc in which the ends are 85 mm apart at the top end, and 95 mm apart at the base end.

### Example 11

### Fire Brick

Cymbopogon citratus plants in a leaf straightening phase were harvested by securing the plant material together with a rope, and then cutting the secured plant material with a chain saw approximately 15 cm above ground level. The harvested plant material was dried as a cut plant for about 3 to 4 weeks undercover on an open deck. The dried plant material was mulched by feeding the plant material stem-first into a semi-commercial garden chip shredder mulcher.

Two tablespoons of plain flour were mixed with 100 mL water, and the mixture stirred so that the water was evenly cloudy in colour.

Mulched plant material was packed into a moulded non-stick muffin tray, squashing the plant material in both manually by hand, and with a juice plunger and spoon. About 5 mL water-flour mixture was then added, and the plant material squashed further, before more plant material was added and the process repeated. In total approximately 150 g of plant material and 12 mL flour water was used per muffin mould. The tray was then baked in a fan-forced oven for 15 min at 180° C. The plant mixture moulds were then taken out of the moulds and allowed to dry on a rack. The fire brick produced is in the shape of a love heart, 65 mm wide, 35 mm deep and 40-60 mm long.

### Example 12

### Particle Board

Plant material from plants of the species Cymbopogon nardus was harvested at the leaf straightening stage and dried in ambient conditions of humidity and sunlight for 3 to 5 days. Once dry, the plant material was mulched. Mulching was repeated until the average particle size was under 60 mm.

The plant material was dusted with ascorbic acid, 3.5-4% by weight of the plant material being treated. Following this treatment, the plant material was dried in a kiln to provide a moisture content below 3%.

Particle boards were prepared to 16 mm thickness using standard techniques with the following components:
1. ascorbic acid treated plant material (containing essential oils) was treated with 15% by weight melamine urea formaldehyde resin, 0.7% by weight wax and 3% by weight ammonium sulphate (hardener).

The product mixture was formed into a mat and hot-pressed.

The product particle boards were tested to Australian Standards AS4266.5 (bending strength, MOR), AS4266.5 (modulus of elasticity, MOE), AS4266.6 (internal bond), AS4266.8 (24 hour thickness swell) and AS4266.10 (wet bonding strength, MOR-A).

The particle board products met the Australian Standards as shown in Table 1:

TABLE 1

| Standard | Australian Standard | | Sample result | |
|---|---|---|---|---|
| Internal Bond | ≧300 | Kpa | 508 | Kpa |
| Elasticity | — | | 2732 | MPa |
| Bend Strength | >12 | MPa | 15 | MPa |
| 24 hr Thickness swell | <15% | | 8.6% | |
| Wet bonding Strength | >4.5 | MPa | 5.0 | MPa |

Those skilled in the art will appreciate that the invention described herein is susceptible to variations and modifications other than those specifically described. It is to be understood that the invention includes all such variations and modifications which fall within the spirit and scope. The invention also includes all of the steps, features, compositions and compounds referred to or indicated in this specification, individually or collectively, and any and all combinations of any two or more of said steps or features.

The claims defining the invention are as follows:

1. An engineered cellulosic product, comprising plant material from a plant of the genus Cymbopogon.

2. The product according to claim 1, wherein the plant of the genus Cymbopogon is selected from the species Cymbopogon ambiguus, Cymbopogon bombycinus, Cymbopogon casesius, Cymbopogon commutatus, Cymbopogon citratus, Cymbopogon citriodora, Cymbopogon excavatus, Cymbopogon flexuosus, Cymbopogon goeringii, Cymbopogon jwarancusa, Cymbopogon martini, Cymbopogon nardus, Cymbopogon obtectus, Cymbopogon pendulus, Cymbopogon procerus, Cymbopogon proximus, Cymbopogon refractus, Cymbopogon schoenanthus and Cymbopogon winterianus, or a combination thereof.

3. The product according to claim 2, wherein the species is selected from Cymbopogon citratus, Cymbopogon flexuosus and Cymbopogon nardus.

4. The product according to claim 1, wherein the plant material from a plant of the genus Cymbopogon is harvested at a time when the plant does not comprise seeds.

5. The product according to claim 1, wherein the plant material from a plant of the genus Cymbopogon is harvested during a leaf straightening phase.

6. The product according to claim 1, wherein the cellulose in the product consists essentially of plant material from a plant of the genus Cymbopogon.

7. The product according to claim 1, wherein the product is selected from a particle board, a medium-density fibreboard, a high-density fibreboard, a cement bonded particleboard, a fibre cement siding, a cross ply board, a dimensioned timber analogue, and a fire brick.

8. The product according to claim 1, wherein the product further comprises an adhesive.

9. The product according to claim 8, wherein the adhesive is selected from a thermosetting polymer and a thermoplastic polymer.

10. The product according to claim 9, wherein the adhesive is selected from a polyvinylacetate resin, a formaldehyde resin, a urea melamine resin, a melamine formaldehyde resin, a urea melamine formaldehyde resin, a phenol formaldehyde resin, a phenol melamine formaldehyde resin, a melamine resin, a urea formaldehyde resin, a melamine urea phenolic formaldehyde resin, a methylene diphenyl diisocyanate resin, a polymethylene diphenyl diisocyanate resin, or a combination thereof.

11. The product according to claim 8, wherein the adhesive is selected from cement, flour and soy flour.

12. The product according to claim 1, further comprising a hydrophilic substance.

13. The product according to claim 12, wherein the hydrophilic substance is a polyhydroxy compound.

14. The product according to claim 13, wherein the polyhydroxy compound is ascorbic acid.

15. A method for producing an engineered cellulosic product, comprising:
(i) Providing processed plant material from a plant from the genus Cymbopogon; and
(ii) moulding the processed plant material.

16. The method according to claim 15, wherein the processed plant material comprises mulched plant material.

17. The method according to claim 15, wherein the plant from the genus Cymbopogon is selected from the species Cymbopogon ambiguus, Cymbopogon bombycinus, Cymbopogon casesius, Cymbopogon commutatus, Cymbopogon citratus, Cymbopogon citriodora, Cymbopogon excavatus, Cymbopogon flexuosus, Cymbopogon goeringii, Cymbopogon jwarancusa, Cymbopogon martini, Cymbopogon nardus, Cymbopogon obtectus, Cymbopogon pendulus, Cymbopogon procerus, Cymbopogon proximus, Cymbopogon refractus, Cymbopogon schoenanthus and Cymbopogon winterianus, or a combination thereof.

18. The method according to claim 17, wherein the species is selected from Cymbopogon citratus, Cymbopogon flexuosus and Cymbopogon nardus.

19. The method according to claim 15, wherein the method further comprises harvesting the plant material.

20. The method according to claim 14, wherein the plant material from a plant of the genus Cymbopogon is harvested at a time when the plant does not comprise seeds.

21-41. (canceled)
